(19) United States
(12) Patent Application Publication
(10) Pub. No.: US 2009/0061667 A1
(43) Pub. Date: Mar. 5, 2009

(54) Electrical Plug Adaptor

(75) Inventor: Timothy B. Grieff, Odell, IL (US)

Correspondence Address: LEMPIA BRAIDWOOD LLC, 223 W. JACKSON BLVD., SUITE 620, CHICAGO, IL, 60606, US

(73) Assignee: GRIEFF ENTERPRISES, INC., Odell, IL (US)

(21) Appl. No.: 12/200,838

(22) Filed: Aug. 28, 2008

Related U.S. Application Data
(60) Provisional application No. 60/968,514, filed on Aug. 28, 2007.

(51) Int. Cl. H01R 13/66

(52) U.S. Cl. 439/151

(57) ABSTRACT

An electrical plug adapter has a plug body, female receptacles in one surface of the plug body, and male prongs extending from another surface of the plug body. The adapter has a male catch mechanism associated with a latching prong of the male prongs. The male catch mechanism is resiliently biased to a catch position relative to the latching prong. An actuator on the plug body can be moved to selectively move the latch mechanism to a release position closer to the latching prong. The male catch mechanism includes a portion configured to catch on an object in a standard electrical outlet when the male prongs are inserted into corresponding receptacles in the standard electrical outlet.

### RELATED APPLICATION DATA

This patent is related to and claims priority benefit of U.S. provisional patent application Ser. No. 60/968,514 filed on Aug. 28, 2008, the entire contents of which are hereby incorporated by reference.

### BACKGROUND OF THE INVENTION

1. Field of the Disclosure

The present disclosure is generally directed to electrical plug adapters, and more particularly to a plug adapter that inhibits unintended removal of the plug from a standard outlet.

2. Description of Related Art

There are many different types of electrical plug adapters known in the art. Many of these adapters are equipped to mate two prong female receptacles with three prong male connectors or vice versa with one another. Most of these known adapters do not provide any enhanced physical connection or lock feature to secure an electrical plug adapter with a mating component. Some known adapters have a locking feature wherein the adapter can be locked with another mating component. These types of adapters typically require a male plug and a female receptacle that each are equipped with a portion of the locking component mechanism, thus requiring a special female socket receptacle and correspondingly special male prong.

U.S. Pat. No. 6,171,129 to Phillips discloses an electrical adapter with a male end and a female receptacle end. The female end is incorporated with a selective lock and release mechanism. A male plug can be inserted into the female receptacle and be retained physically therein. Two of the three male prongs on the male end of the adapter are equipped with a spring device. These spring devices can be moved from one position where they engage the prongs to permit insertion and removal of the male prongs from a female receptacle. These spring devices can also be moved to another position where a portion of the devices are spaced from the respective male prongs and engage a part of the receptacle to securely retain the male prongs in the female receptacle. A first button or actuator is provided on the adapter to actuate both of the springs. A second button or actuator is also provided on the adapter to actuate the lock and release mechanism at the female end.

U.S. Pat. No. 7,077,683 to Ross discloses an electrical plug adapter with a male prong that has a serrated or sawtooth configuration. Ross also discloses a female receptacle with a release and lock device. That device includes a tooth within the female receptacle that can engage with, or be moved out of engagement with, a saw-toothed edge of the male prong. Thus, Ross requires a specialized female receptacle to engage the specialized male prong in order to function properly.

### BRIEF DESCRIPTION OF THE DRAWINGS

Objects, features, and advantages of the present invention will become apparent upon reading the following description in conjunction with the drawing figures, in which:

FIG. 1 shows a side view representative of one example of a plug adapter constructed in accordance with the teachings of the present invention.

FIG. 2 shows an end view of the male end of the plug adapter shown in FIG. 1.

FIG. 3 shows an end view of the female end of the plug adapter shown in FIG. 1

FIG. 4 shows a longitudinal cross-section along line IV-IV through the plug adapter shown in FIG. 1.

FIG. 5 shows a side view representative of another example of a plug adapter constructed in accordance with the teachings of the present invention.

FIG. 6 shows another example of a plug adapter constructed in accordance with the teachings of the present invention.

FIG. 7 shows another example of a plug adapter constructed in accordance with the teachings of the present invention.

FIG. 8 shows a perspective view of another example of a plug adapter constructed in accordance with the teachings of the present invention.

FIG. 9 shows an end view of the female end of the plug adapter shown in FIG. 8.

FIG. 10 shows a side view of the plug adapter shown in FIG. 8.

FIG. 11 shows a cross section along line XI-XI through the plug adapter shown in FIG. 8.

### DETAILED DESCRIPTION OF THE DISCLOSURE

The plug adapter examples disclosed herein solve or improve upon one or more of the above-noted and/or other problems and disadvantages with known plug adapters. In one example, a plug adapter disclosed herein utilizes a device on a single male prong to engage with and be selectively released from engagement within a standard, conventional female electrical socket receptacle. In another example, a plug adapter is disclosed herein that has a female receptacle configured to permanently connect to one or more male prongs of a standard electrical connector from an appliance, tool, or the like.

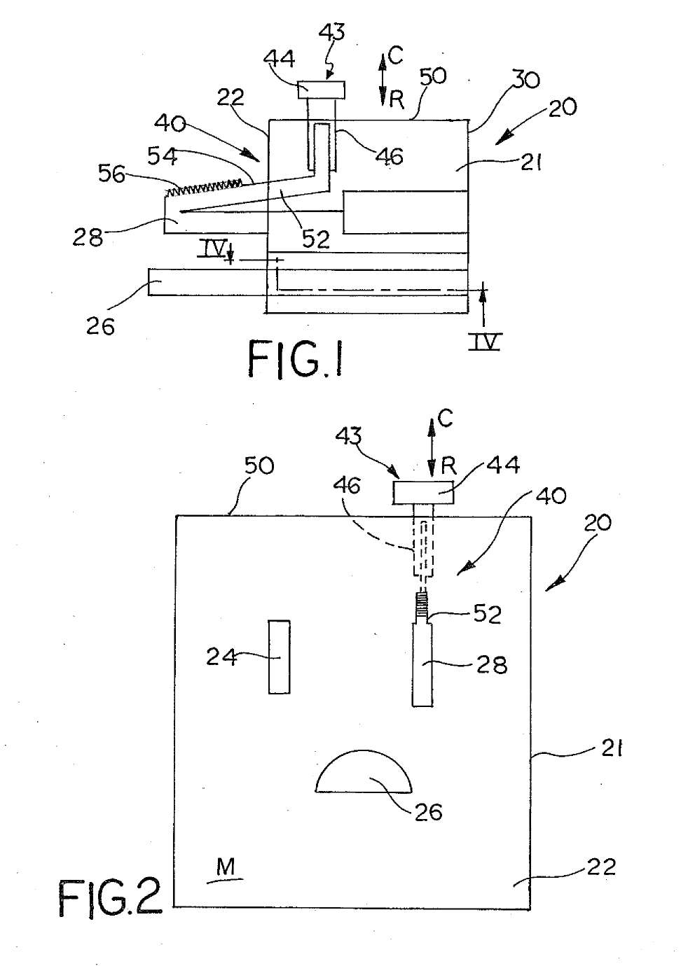

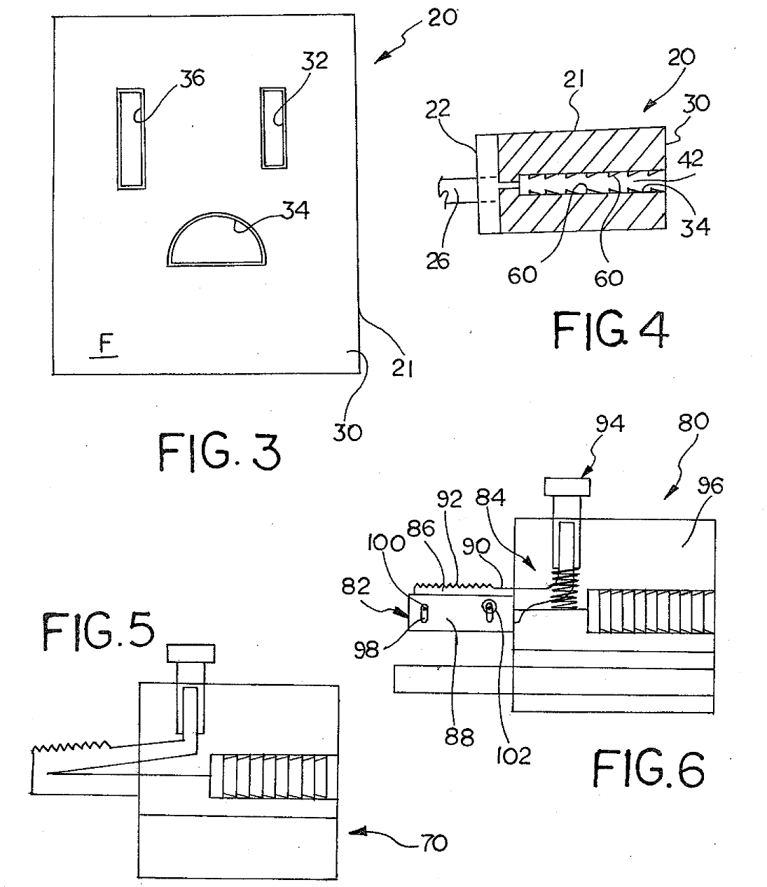

Turning now to the drawings, FIG. 1 shows a schematic or cut away side view of one example of a plug adapter 20 constructed in accordance with the teachings of the present invention. In this example shown in FIG. 2, the plug adapter 20 has a plug body 21 with three male prongs extending from a surface M on a male end 22 of the body. The three male prongs in this example include a positive male prong 24, a ground male prong 26, and a neutral male prong 28. The plug body 21 also has a surface F on a female end 30 as shown in FIG. 3 with three female receptacles into the surface F. The three receptacles in this example include a positive receptacle 32 for receiving a positive male prong, a ground receptacle 34 for receiving a ground male prong, and a neutral receptacle 36 for receiving a neutral male prong of an electrical plug (not shown) from a tool, appliance, or the like.

As will be evident to those having ordinary skill in the art upon reading this disclosure, the number, size, orientation, and arrangement of the prongs and receptacles can vary from that shown. Additionally, the size and configuration of the plug body and the material from which it is made can also vary. Further, the material and construction of the receptacles and prongs can also vary within the spirit and scope of the invention.

In this example, one of the male prongs of the adapter 20, the neutral prong 28 for example, can be configured as a male latching prong. Here, the neutral or latching prong 28 has a male catch or plug retention mechanism 40. The male catch mechanism 40 can be selectively moved from a lock or catch position to a release position as shown in FIG. 1 via the arrows C (catch direction) and R (release direction). Also in this example, one of the female receptacles, receptacle 34 for example as in FIGS. 1 and 4, can have a “permanent,” one-way, or non-releasable female catch or prong retention mechanism 42 for coupling with a male prong on a plug of a tool, appliance, or the like. In this example, the plug adapter 20 is thus configured for particular use on a device or appliance where there is no intention of removing the plug adapter from the appliance cord once attached.

In one example, the male catch mechanism 40 on the single male prong 28 is actuated or moved via an actuator 43 on the plug body. In one example, the actuator 43 can include a push button 44 coupled to a stalk 46 that projects from a surface of the plug body 21. In this example, the push button 44 projects from the top surface 50 of the plug body 21. The push button 44, and in this case the stalk 46, can be coupled to a resiliently movable portion 52 of the male prong 28. In the disclosed example, the movable portion 52 of the prong 28 includes one edge 54 with a plurality of teeth 56 that form a serrated or sawtooth configuration.

The prong 28 in this example can be formed at least partly of a resilient material such as spring steel so that the teeth 56 are biased upward, away from the prong 28, to the locked or catch position. Thus, the portion 52 can be integrally formed as a part of the prong 28, if desired. In another example, the movable portion can be a separate component that is pivotally, laterally, translationally, and/or slidably joined to the prong 28. Thus, the portion 52 need not be formed of the same material as the prong 28, i.e., metal. Instead, the portion 52 can be formed of a plastic material or other suitable material, if desired. A biasing element, such as a spring, can also be employed, if desired, to bias the portion 52 away from the prong 28 to the catch position.

Depressing the button 44 of the actuator 43 into the plug body 21 in this example will drop or move the serrated edge 56 toward the prong 28. This will create clearance between the teeth 56 and an exposed surface, edge, or object inside a conventional socket receptacle (not shown). The clearance will permit the male prongs 24, 26, and 28 to be inserted into or removed from a conventional female receptacle or outlet. Releasing the button 44 allows the resilient nature of the portion 28 to raise or move the serrated edge 54 away from the prong 28, creating interference contact between one of the teeth 56 on the serrated edge and a shoulder, surface, edge, or object (not shown) within a conventional female socket receptacle. The male catch prong 28 can be provided on any one of the prongs including the “hot” or positive prong, the “ground” prong, or the “neutral” prong (as shown) or on more than one of the prongs.

In one example, the permanent or one-way female catch mechanism 42 in the single female receptacle 34 can be provided in multiple ones of the female receptacles, or in only one of the receptacles, as desired. The female catch mechanism 42 in FIGS. 1 and 4 can be provided in the form of a plurality of one-way metal projections or tangs 60 extending laterally from the side surfaces 62 in the receptacle space 34. The projections 60 can be shaped and oriented in a direction to permit insertion of a male prong into the female receptacle. The projections 60 can have sharp barbs or ends angled away from the insertion direction, as shown in FIG. 4, that dig into the material of a male prong upon insertion into the female receptacle 34. The angle and construction of the sharp tangs or ends 60 can thus prevent or significantly inhibit the male prong from being withdrawn from the receptacle 34 once inserted.

As will be evident to those having ordinary skill in the art, the configuration and construction of the female catch mechanism of the disclosed adapter can vary and yet fall within the spirit and scope of the present invention. The intention is that once the disclosed adapter is attached to the cord plug of an appliance, tool, or the like, it is difficult to remove. The configuration and construction of the male, releasable, catch mechanism can also vary from the examples shown. The male catch mechanism is a releasable device that allows the plug adapter to be inserted into, positively retained in, and selectively released from a standard outlet or electrical socket. Thus, the disclosed adapter 20, if the female catch mechanism 42 is utilized, is quite suitable for use on devices and in situations and circumstances where installation of the adapter plug 20 on an appliance cord is intended to be permanent and where installation into a standard outlet or socket is intended to be retained until one desires to unplug the appliance from the outlet.

As a result, the disclosed adapter is particularly useful for construction tools and in construction sites. A typical worker will not need to remove the adapter plug from the tool or device once installed, but will want the adapter plug to be removable from the electrical outlet, but only when desired. A separate adapter can be applied to each of the tools or devices in the field, if desired. During use, the disclosed adapter 20 is intended to stay plugged in if knocked, tugged, or bumped inadvertently. The male catch mechanism can be configured to employ a break-away aspect where, if bumped, knocked, or tugged too hard, the catch mechanism will release or break without harming the outlet or the appliance cord. Once broken away, the plug adapter could be used without the releasable catch feature or the entire adapter and plug end on the appliance cord could be replaced.

As shown in FIGS. 1-3, the disclosed adapters can be configured to have three female receptacles on the female end and three male prongs on the male end for a conventional U.S. grounded connection. Clearly, other plug receptacle and prong arrangements, such as old technology and non-U.S. technology configurations, can fall within the spirit and scope of the present invention, as noted above. For example, a typical two prong and two receptacle plug can be configured and yet fall within the spirit and scope of the present invention. FIG. 5 shows an alternative plug adapter 70 with such an arrangement, i.e., with no male ground prong and no female ground receptacle.

FIG. 6 illustrates another example of a plug adapter 80 constructed in accordance with the teachings of the present invention. This example illustrates a modified male latching prong 82 with a male catch mechanism 84 is illustrated. The male latching prong 82 in this example includes a dual blade construction that has two blade portions 86 and 88 that are positioned side-by-side adjacent one another. One of the blade portions 86 can move up and down relative to the other fixed blade portion 88. In this example, the movable blade portion 86 has a top edge 90 with serrations or teeth 92 similar to the prior example. A button or other actuator 94 can be provided on the plug body 96 that can be manipulated to move the serrated blade portion 86 toward or in line with the fixed portion 88 in a release position. In the release position, the prong portion 86 will permit insertion of the prong 86, 88 into and removal from a female receptacle. The button or actuator 94 can be released to cause the serrated movable prong portion 86 to move away from or out of alignment with the fixed portion 88 to a catch position. In the catch position, the teeth are positioned to catch on a surface, object, edge, or shoulder within the standard outlet female receptacle to retain the plug adapter in the installed condition. In one example, slots 98 and pins 100 with torsion springs 102 can be provided connecting the two blade portions 86, 88 together and biasing the movable blade portion upward as shown. The button or actuator 94 can be configured to overcome the biasing force of the springs 102 to lower the movable blade portion 86.

Other biasing arrangements, catch or locking mechanisms, and prong or blade configurations can also be designed and yet perform the intended functions. In the example of FIG. 1, the biased movement of the male prong with the serrated top edge can also be employed in a variety of ways and yet fall within the spirit and scope of the present invention. In the example shown, the male prong can be configured as a unitary spring-steel or other resilient material prong with one part resiliently movable relative to the other part. In another example, one of the two parts can be pivotally connected and spring biased upward relative to the other part. In a further example, an entire male prong can be positioned and configured on the plug so that the entire prong can move upward or downward relative to the plug adapter body or housing.

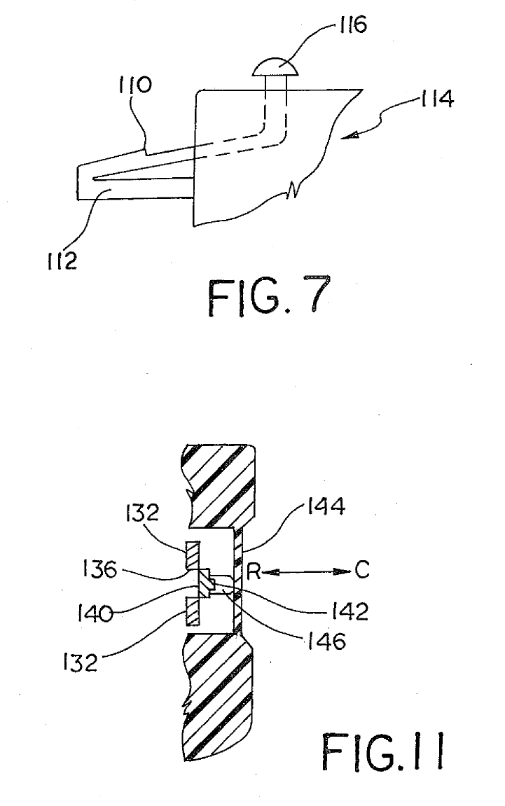

The male catch mechanisms in the disclosed examples include a serrated edge with multiple serrations. The serrations can be formed so that the male end can be readily and easily inserted into a conventional female socket receptacle and yet prevent withdrawal unless the button or actuator is depressed. If desired, the serrations can be formed to permit insertion of the male prong without having to depress the actuator or button. As shown in FIG. 7, the multiple serrations on one of the prongs can be replaced by a single serration 110, hook, tooth, or the like. In this example, the single tooth can be positioned along the latching prong 112 so as to cooperate with a shoulder, lip, protrusion, surface, object, or edge in a conventional receptacle or socket structure to retain the adapter 114 within the female socket until the actuator or release button 116 is used to release the adapter.

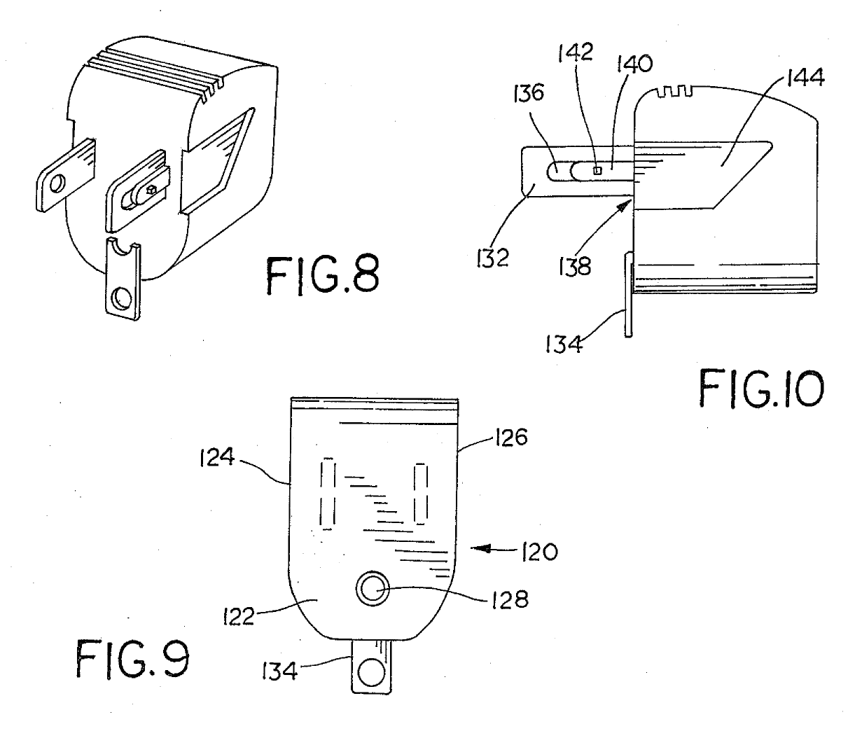

FIGS. 8-11 show yet another example of a plug adapter 120 constructed in accordance with the teachings of the present invention. In this example, the adapter 120 has a plug body 122 with three female receptacles 124, 126, and 128 depicted in FIG. 9. As with the first example discussed above, one of these receptacles can be provided with a one-way female catch mechanism if desired. The adapter 120 also has three male prongs 130, 132, and 134 depicted in FIG. 8. The latching prong 132 in this example is a flat blade with a central opening 136 in the blade and has a releasable male catch mechanism 138 associated with the prong. The mechanism 138 has a catch blade 140 seated in the central opening. The catch blade 140 is biased to a plane that is offset relative to a plane of the latching prong blade as shown in FIG. 8.

In this example, the catch prong 140 can be formed of a material that is different from the latching prong 132, such as plastic. The catch prong can have a tooth 142, projection, hook, catch, or the like that projects outward from a side of the prong, in this instance outward in a direction away from the prong 130. The plastic can be formed as a resilient finger or blade 140 or can be resiliently biased by a spring or other biasing device outward to the offset catch position in the direction of the arrow C. As shown in FIGS. 8, 10, and 11, an actuator surface 144 on a side of the plug body can be squeezable inward, or both sides of the body can be squeezed inward into the body. Movement in this release direction R can cause the catch prong to move into co-planar alignment with the latching prong 132, or further into the opening 136, so that the tooth or projection 142 lies flush or nearly flush with the prong 132. In this position, the catch prong will permit the prong 132 to be inserted into or released from an outlet receptacle.

In one example, the actuator surface can be positioned over a pocket 146 in the plug body 122 as in FIG. 11. The actuator surface 144 can be a thinner wall thickness or membrane that is squeezable or movable relative to the surrounding body. A contact 148 can be provided on the catch prong 140 that is in contact with the actuator surface 144. When moved or squeezed inward, the surface 144 can push the contact inward, which in turn will push the catch prong to the release position in alignment with the latching prong 132.

By forming the catch prong from plastic, the shape and size of the projection 142 can be designed to retain the plug adapter 120 installed until a break away or removal threshold force is reached. Upon surpassing the threshold force, the catch prong and/or the tooth or projection 142 can be designed to release from the outlet socket or break.

In other embodiments, the button or actuator can be replaced with a sliding device, a twisting actuator, or other mechanism that can move the single male catch prong of the disclosed adapters. In addition, the button or other actuator can be placed anywhere on the plug body or housing within the spirit and scope of the invention. The button or actuator can be placed on a top of the adapter body as shown in the drawings herein. Alternatively, the button or actuator can be placed on either side or on the bottom of the adapter body and yet fall within the scope of the invention. In one example, two different adapters can be provided for use in a standard double receptacle socket. One of the adapters can have an actuator that is accessible on a top of the body for use within an upper one of the female receptacles of the outlet or socket. Another of the adapters can have an actuator that is accessible on the bottom of the adapter body for use within a bottom one of the female receptacles of the outlet or socket. In a further example, both adapters can have an actuator on a side of the adapter body, thus rendering the actuator accessible regardless as to whether the adapter is inserted into an upper or lower one of the standard female receptacles of the double outlet or socket.

In another example of the invention, an extension cord can be provided that has a female end that is compatible with the disclosed adapters and that has a male lock and release end. The male end of the extension cord can include two or more male prongs with one of the prongs incorporating the lock and release feature as described above. The female end of the extension cord can include a female receptacle that is configured to include a shoulder, lip, protrusion, or catch surface identical to or similar to that of a standard socket receptacle. Thus, the extension cord could be used in conjunction with one of the adapters described above wherein the male end of the extension cord is releasably inserted into a standard socket outlet and the female end receives the releasable male prongs of a previously described adapter, which has been connected to a power cord of an electronic device.

Although certain plug adapters have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. An electrical plug adapter comprising:
a plug body;
female receptacles in one surface of the plug body;
male prongs extending from another surface of the plug body;
a male catch mechanism associated with a latching prong of the male prongs and resiliently biased to a catch position relative to the latching prong; and
an actuator on the plug body that can be moved to selectively move the latch mechanism to a release position closer to the latching prong,
wherein the male catch mechanism includes a portion configured to catch on an object in a standard electrical outlet when the male prongs are inserted into corresponding receptacles in the standard electrical socket.

2. An electrical plug adapter according to claim 1, wherein a retention receptacle of the female receptacles has a one-way catch mechanism therein configured to prevent removal a corresponding prong of an appliance plug inserted into the female receptacles.
